(19) United States
(12) Patent Application Publication
(10) Pub. No.: US 2025/0358656 A1
(43) Pub. Date: Nov. 20, 2025

(54) INTERACTIONS BETWEEN MEASUREMENT SERVICES AND CONNECTIVITY SERVICES

(71) Applicant: QUALCOMM Incorporated, San Diego, CA (US)

(72) Inventors: Shankar KRISHNAN, Poway, CA (US); Karl Georg HAMPEL, Jersey City, NJ (US); Naeem AKL, Bridgewater, NJ (US); Prasada Veera Reddy KADIRI, San Diego, CA (US); Gavin Bernard HORN, La Jolla, CA (US)

(21) Appl. No.: 18/669,269

(22) Filed: May 20, 2024

(51) Int. Cl. H04W 24/10

(52) U.S. Cl. CPC H04W 24/10

(57) ABSTRACT

Method and apparatus for interactions between measurement services and connectivity services. The apparatus establishes a first association with a UE via a first radio channel with a first eDU. The apparatus provides, to the UE, a configuration of a second association for communication with an MS. The apparatus provides, to the MS, a request for delivery of a measurement report from the UE. The apparatus may select the MS to obtain the measurement report from the UE. The apparatus may initiate a switch to a target eDU based on the measurement report obtained from the MS. The apparatus may provide the MS with a target eDU ID in response to the switch to the target eDU. The apparatus may cancel delivery of the measurement report for the UE in response to a release of the connection of the UE or receipt of an indication of the release of the UE.

### TECHNICAL FIELD

The present disclosure relates generally to communication systems, and more particularly, to a configuration for interactions between measurement services and connectivity services in wireless networks.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus establishes a first association with a connection service (CS) via a first radio channel with a first enhanced distributed unit (eDU). The apparatus receives, via the first association, a first configuration for a second radio channel of the first eDU. The apparatus receives, via a second association with a measurement service (MS), a first measurement configuration via the second radio channel. The apparatus transmits, via the second association, a first measurement report via the second radio channel based on the first measurement configuration.

In an aspect of the disclosure, a method, a computer-readable medium, and an apparatus are provided. The apparatus may be a device at a network entity. The device may be a processor and/or a modem at a network entity or the network entity itself. The apparatus establishes a first association between a UE and a CS via a first radio channel. The apparatus provides, to the UE via the first association, a first configuration for a second radio channel of the first eDU, wherein the first configuration is obtained from the CS. The apparatus provides, to the UE via a second association with an MS, a first measurement configuration via the second radio channel, wherein the first measurement configuration is obtained from the MS. The apparatus obtains, via the second association, a first measurement report via the second radio channel based on the first measurement configuration.

In an aspect of the disclosure, a method, a computer-readable medium, and an apparatus are provided. The apparatus may be a device at a network entity, such as a CS. The device may be a processor and/or a modem at a network entity or the network entity itself. The apparatus establishes a first association with a UE via a first radio channel with a first eDU. The apparatus provides, to the UE, a configuration of a second association for communication with a MS. The apparatus provides, to the MS, a request for delivery of a measurement report from the UE.

In an aspect of the disclosure, a method, a computer-readable medium, and an apparatus are provided. The apparatus may be a device at a network entity, such as an MS. The device may be a processor and/or a modem at a network entity or the network entity itself. The apparatus obtains a request for delivery of a measurement report from a UE. The apparatus provides, to the UE, a measurement configuration via a radio channel of an eDU. The apparatus obtains, from the UE, a measurement report via the radio channel based on the measurement configuration. The apparatus provides the measurement report to at least a CS.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example function split between a core network and a RAN.

FIG. 4B is a diagram illustrating example aspects of a cloud native platform for a wireless network that may include a merger of core network and RAN services, in accordance with various aspects of the disclosure.

FIG. 5 illustrates an example functional split between the core network and the RAN, in accordance with various aspects of the disclosure.

FIG. 6A is a diagram illustrating an example of a CU-CP function, in accordance with various aspects of the disclosure.

FIG. 6B is a diagram illustrating an example of a separation of CU-CP functional blocks into separate logical entities, in accordance with various aspects of the disclosure.

FIG. 7 is a diagram illustrating an example of a CS and a MS as separate logical entities in a communication network, in accordance with various aspects of the disclosure.

FIG. 8 illustrates an example call flow diagram illustrating an example of a UE access procedure, in accordance with various aspects of the present disclosure.

FIG. 9 illustrates an example of a L3 handover with a relocation of a CS, in accordance with various aspects of the present disclosure.

FIG. 10 illustrates an example of a relocation of a MS, in accordance with various aspects of the present disclosure.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a flowchart of a method of wireless communication.

FIG. 16 is a diagram illustrating an example of a hardware implementation for an example network entity.

FIG. 17 is a flowchart of a method of wireless communication.

FIG. 18 is a flowchart of a method of wireless communication.

FIG. 19 is a diagram illustrating an example of a hardware implementation for an example network entity.

FIG. 20 is a flowchart of a method of wireless communication.

FIG. 21 is a flowchart of a method of wireless communication.

FIG. 22 is a diagram illustrating an example of a hardware implementation for an example network entity.

### DETAILED DESCRIPTION

In 5G, the CU-CP function has multiple tasks such as connection control, measurement control, inter-cell resource coordination, automatic neighbor relation, or the like. In 6G, a move to a “cloud-native” architecture may allow for the CU-CP to be retained as one logical entity, or whether the various tasks of the CU-CP to be considered as separate logical entities. In such instances the separate logical entity may be deployed more flexibly at different locations (e.g., in cloud vs. at eDU, or at different clouds).

The scope of function between connection control and measurement control is distinct. For example, connection control manages the relation between a pair of nodes. Measurement control manages the acquisition of information by a single node. In some cases, connection control has become increasingly independent of instant measurements. Other functional entities may be independent of the connection control that may also utilize measurements information. Measurements may be collected from eDUs and/or non-data-service nodes. Measurement configurations may be released when the UE becomes idle/inactive, as opposed to some of the connection-related context. Measurement control therefore has lower state-management overhead. It may be possible to decouple the connection control and the measurement control, such that there are two distinct services. As such, it may be desirable to separate connection control and measurement control into separated logical entities, such as in 6G or other technologies.

Aspects presented herein provide a configuration for connection control and measurement control being separate logical entities. The separation of connection control and measurement control into separate logical entities may reduce overhead and improve overall performance.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

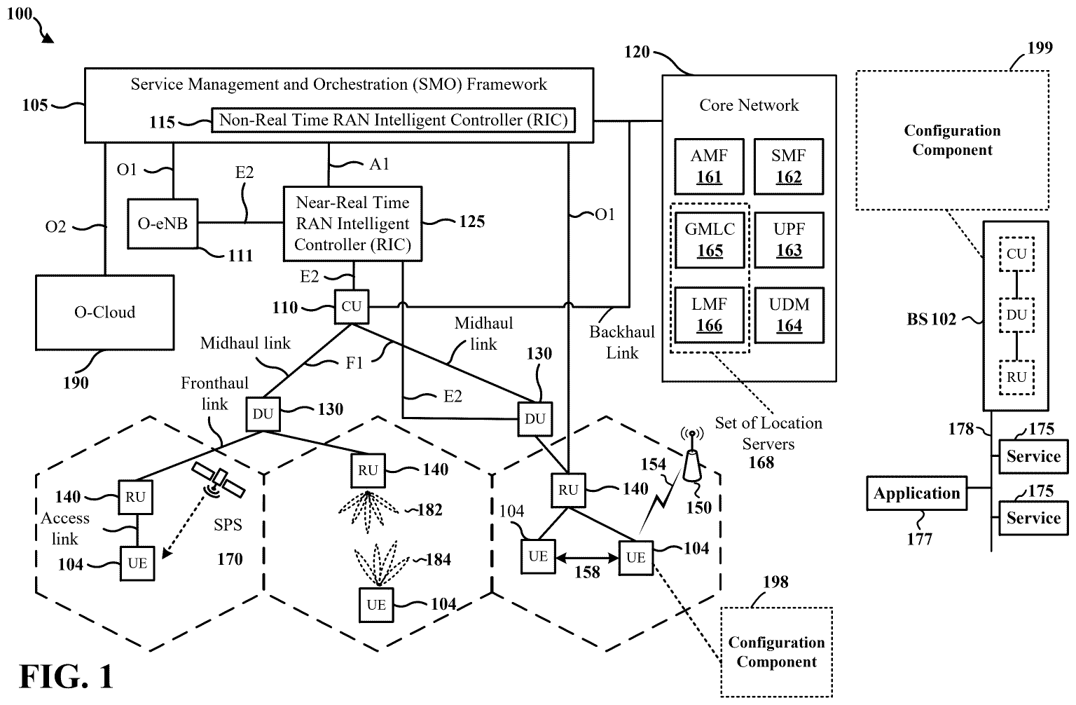

FIG. 1 is a diagram 100 illustrating an example of a wireless communications system and an access network. The illustrated wireless communications system includes a disaggregated base station architecture. The architecture of the disaggregated base station may include one or more CU (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC (e.g., a Non-RT RIC 115) associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

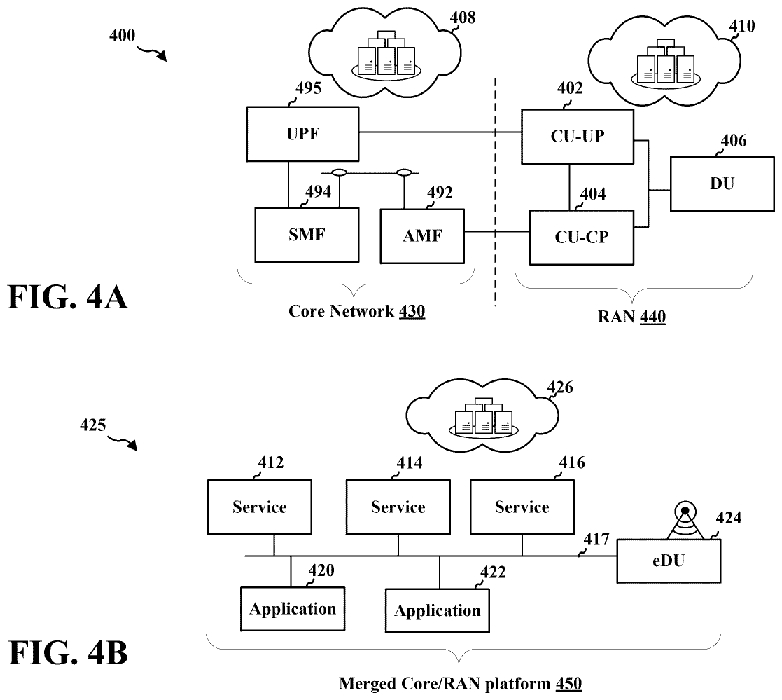

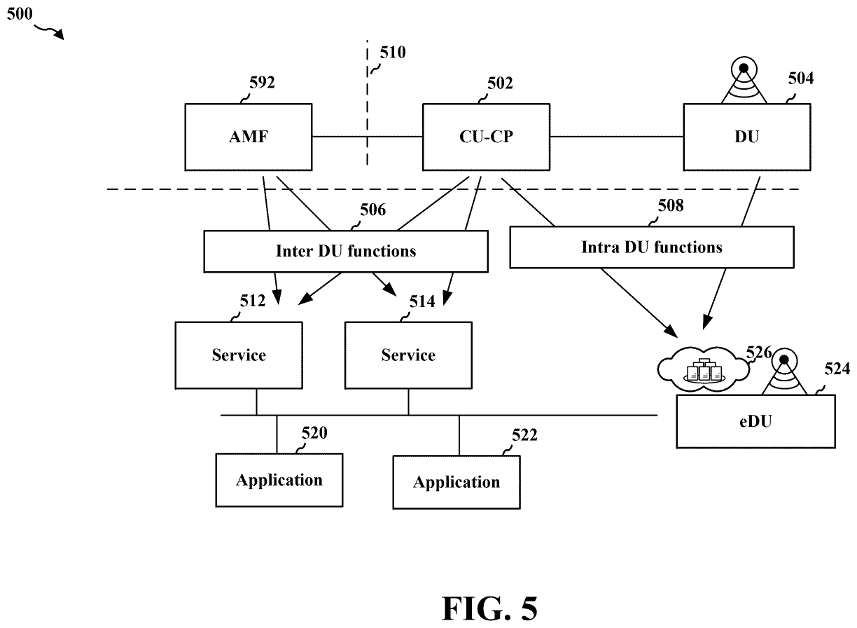

The base stations 102 configured for 5G NR (collectively referred to as Next Generation RAN (NG-RAN)) may interface with core network 120 through backhaul links. The radio nodes configured for 6G, or other service-based architectures, may have an API interface 178 with various services of the core network, such as described in connection with any of FIG. 4B or 5, for example. The service-based architectures may include services, e.g., as represented by service 175 and applications 177. FIG. 1 illustrates a DU as an example radio node, although such radio nodes may also be referred to as an enhanced DU (eDU), a network node, a network entity, or by other names.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a configuration component 198 that may be configured to establish a first association with a CS via a first radio channel with a first eDU; receive, via the first association, a first configuration for a second radio channel of the first eDU; receive, via a second association with a MS, a first measurement configuration via the second radio channel; and transmit, via the second association, a first measurement report via the second radio channel based on the first measurement configuration.

Referring again to FIG. 1, in certain aspects, the base station 102 may include a configuration component 199 that may be configured to establish a first association between a UE and a CS via a first radio channel; provide, to the UE via the first association, a first configuration for a second radio channel of the first eDU; provide, to the UE via a second association with a MS, a first measurement configuration via the second radio channel; and obtain, via the second association, a first measurement report via the second radio channel based on the first measurement configuration.

Although the following description may be focused on 5G NR, the concepts described herein may be applicable to other similar areas, such as LTE, LTE-A, CDMA, GSM, and other wireless technologies.

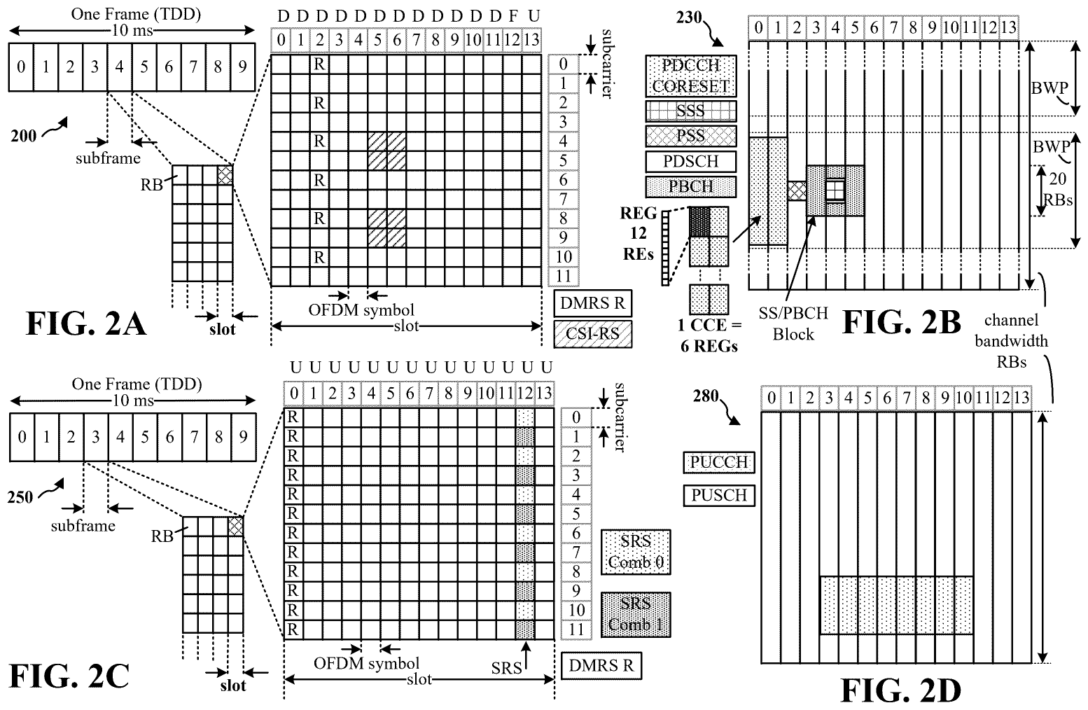

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

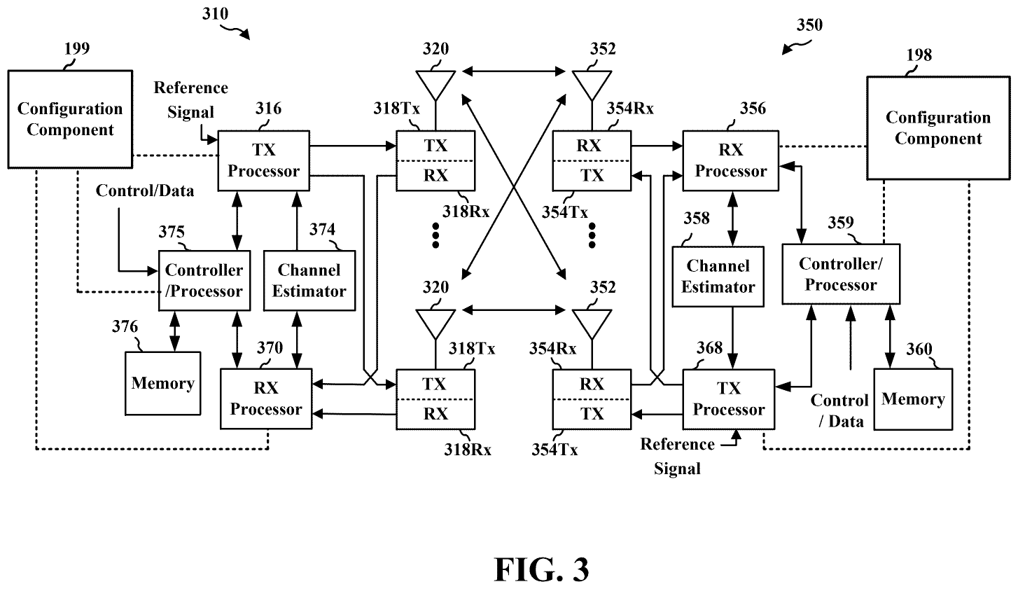

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the configuration component 198 of FIG. 1.

At least one of the TX processor 316, the RX processor 370, and the controller/processor 375 may be configured to perform aspects in connection with the configuration component 199 of FIG. 1.

FIG. 4A is a diagram 400 illustrating an example function split between a core network 430 and a RAN 440. FIG. 1 illustrates an example aspect of a core network (e.g., core network 120), and illustrates an example of a base station 102/180 as a RAN. FIG. 4A shows the UPF 495, SMF 494, and AMF 492 as part of the core network 430. FIG. 4A shows the CU-UP 402 (e.g., that provides user plane functionality), the CU-CP 404 (e.g., that provides control plane functionality), and the DU 406 provided as part of the RAN 440. The CU-CP and/or CU-UP may include aspects described for the CU 110 in FIG. 1. The DU 406 may include aspects described for the DU 130 in FIG. 1. Aspects of the core network/RAN hierarchy in FIG. 4A may be employed, e.g., in 3G, 4G, and/or 5G wireless networks, as an example. The functional split in FIG. 4A may help to maintain performance and security of a wireless network and accessibility of on-site equipment. FIG. 4A illustrates that some aspects of the core network 430 may include a cloud platform 408, and some aspects of the RAN 440 may include a cloud platform 410.

FIG. 4B is a diagram 425 illustrating example aspects of a cloud native platform (e.g., as shown at 426) for a wireless network that may include a merger (or combined functionality) of core network and RAN services. The platform may be referred to as a merged Core/RAN platform 450, for example. The combination of the functions between the core network and the RAN may simplify protocols and reduce duplication across the core network and RAN. FIG. 4B illustrates that services (which may include merged services that combine core network and RAN functionality) can be hosted in the wireless network based on a deployment topology and/or capabilities for each service's requirements. FIG. 4B illustrates multiple services 412, 414, and 416; multiple applications 420 and 422; and an eDU 424 as part of the merged Core/RAN platform 450. The platform enables each service 412 to be updated independently of the other services. The services provide various functions for the wireless network. Examples of services may include access control services, mobility services, PWS services, V2X services, MBS services, and positioning services, among other examples. The platform may use an API interface 417, for example.

FIG. 5 is a diagram 500 showing a converged service-based core network and RAN and shows that various functions performed by the core network (e.g., AMF 592) and the RAN (e.g., CU-CP 502 and/or the DU 504) can be distributed across the service-based platform described in connection with FIG. 4B. FIG. 5 illustrates an example functional split 510 between the core network (e.g., 592) and the RAN (e.g., 502 and 504). As illustrated by the arrows, various aspects of the inter-DU functions 506 that are performed by the AMF 592 and/or the CU-CP 502 can be performed by different services 512 and 514 in the service-based architecture. FIG. 5 illustrates that intra-DU functions 508 performed by the CU-CP 502 and/or the DU 504 can be performed by the eDU 524 (as an example of a network node or radio node) using the cloud based architecture 526. FIG. 5 also illustrates that the service-based architecture may include one or more applications 520 and 522.

The converged service-based core network and RAN may include a single cloud platform to host application(s), and the core network and RAN services, for example. The architecture can extend the benefits of a service-based architecture to the RAN. The architecture may enable benefits relating to a cloud-based system, e.g., including scalability, elasticity, resilience, reuse, agility, visibility, automation, and/or protection in case of failure, among other benefits. Each service (e.g., 412 or 512) can be scaled independently, and resources can be increased or decreased for individual services.

The functional split (e.g., as shown at 510) for the core network and RAN can be adjusted in order to leverage cloud deployments (e.g., in comparison to an appliance centered architecture). Such cloud platforms enable a redistribution of services or functions of the core network and RAN, and enables applications to share the common platform. The cloud-based architecture enables real-time link management to the RAN edge. Adaptation at the DU, e.g., eDU or radio node, enables more efficient activation/deactivation/selection of features based on the intended user experience.

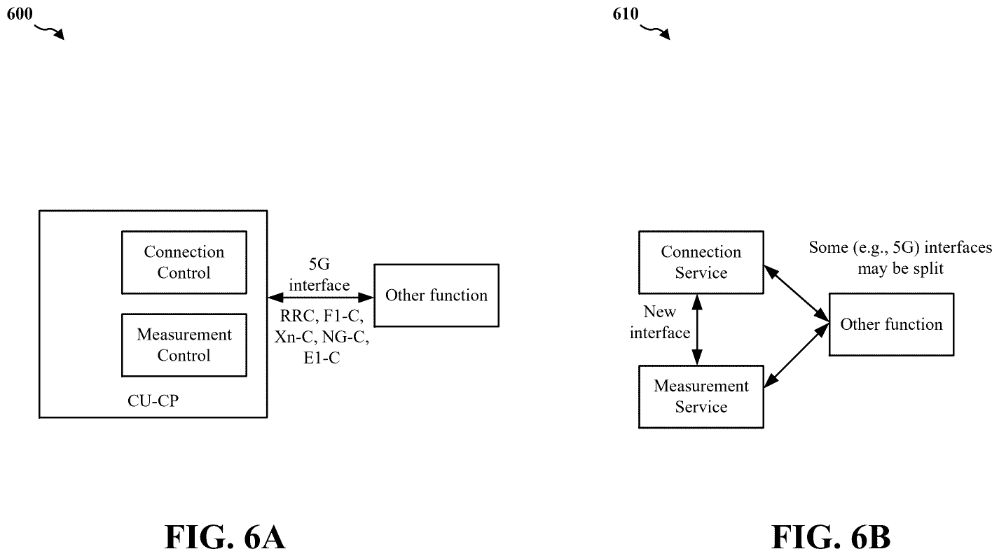

In 5G, the CU-CP function has multiple tasks such as connection control, measurement control, inter-cell resource coordination, automatic neighbor relation, or the like, as shown for example in diagram 600 of FIG. 6A. In 6G or other technologies, a move to a “cloud-native” architecture may allow for the CU-CP to be retained as one logical entity, or may allow for the various tasks of the CU-CP to be divided and assigned to separate logical entities. In such instances the separate logical entity may be deployed more flexibly at different locations (e.g., in cloud vs. at eDU, or at different clouds). If CU-CP functional blocks are separate logical entities, as shown for example in diagram 610 of FIG. 6B, a new signaling between the separate logical entities would be needed, such as when the gNB was split into DU, CU-CP and CU-UP. Further, some of the CU-CP interfaces may be split to communicate with the separate logical entities. Aspects disclosed herein discuss aspects where the CU-CP tasks of connection control and measurement control are moved to separate logical entities, such as in 6G in one example.

The CU-CP tasks of connection control may include deciding to establish or release a connection of a UE via a DU, layer 3 (L3) handover (e.g., deciding to change a connection of a UE from DU1 to DU2), dual connectivity (e.g., deciding to add/modify/release a connection from a UE with a secondary cell group), sending configuration information to the DU (e.g., F1 application protocol (F1AP) UE context setup/modification procedures) and to the UE (e.g., RRC setup/reconfiguration procedures), support of related procedures (e.g., resume/suspend, reestablishment, etc.), or support of APIs/interfaces to external functions (e.g., Near-RT RIC to remotely control the radio links). The CU-CP tasks of measurement control may include creating the L3 measurement configuration for a UE, including neighbor list, sending the L3 measurement configuration to the UE, receiving the measurement reports from the UE, configuring SRS measurements on the DU and receiving reports on SRS measurements from an DU, or forwarding measurement information (e.g., via E2 to Near-RT-RIC, etc.).

The scope of function between connection control and measurement control is distinct. For example, connection control manages the relation between a pair of nodes (e.g., UE and DU for Uu, or between two UEs for sidelink). Measurement control manages the acquisition of information by a single node (e.g., a UE). In 5G, connection control has become increasingly independent of instant measurements. For example, 5G has moved toward conditional handover (CHO), conditional primary and secondary cells (PSCell) addition and change (CPAC), and lower layer triggered mobility (LTM), where the execution of CU-CP configurations may be triggered locally (e.g., at UE and DU) and is independent of measurements obtained at the CU-CP. There are other functional entities that are independent of the_connection control, that may also utilize measurements information (e.g., positioning, inter-cell interference coordination (ICIC), dynamic activation/deactivation of cells for NES, RIM, etc.). Measurements may also be collected from eDUs and/or non-data-service nodes. The corresponding measurement control utilizes knowledge of all RS resources (e.g., SSB, CSI-RS, SRS) configured at various places, without sharing such information with the connection control. Some devices may utilize connection control (e.g., IoT devices) while others may utilize measurement control (e.g., data-only services). Measurement configurations may be released when the UE becomes idle/inactive, as opposed to connection-related context. Measurement control therefore has lower state-management overhead. In 6G, it is very possible to decouple the connection control and the measurement control, such that there are two distinct services. As such, it would be desirable to separate connection control and measurement control into separated logical entities, such as in 6G.

Aspects presented herein provide a configuration for connection control and measurement control being separate logical entities. The separation of connection control and measurement control into separate logical entities may reduce overhead and improve overall performance. At least one advantage of the disclosure is that having the connection control and measurement control being separate logical entities may allow for providing connection control or measurement control to devices in an optimized manner that may not need both connection control and measurement control.

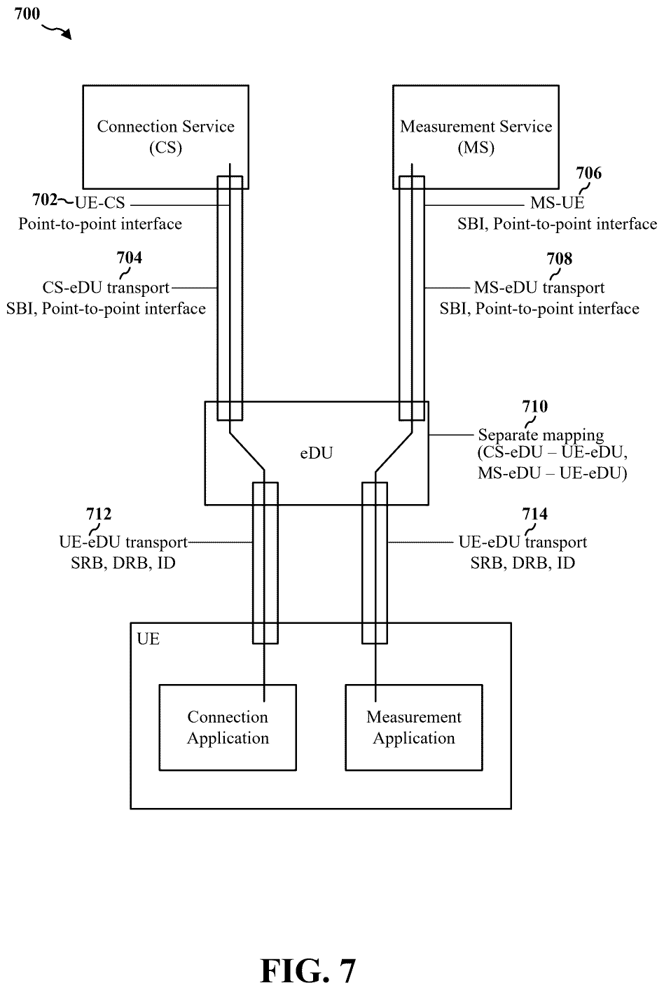

FIG. 7 is a diagram 700 of a CS and a MS as separate logical entities. In some aspects, RRC may be separated into two bidirectional channels, a UE-to-CS and a UE-to-MS channel. In some instances, a CS may communicate with a UE via an interface 702 (e.g., a point-to-point interface). A first transport interface 704 may be utilized for communication between the CS and eDU. The first transport interface 704 may include a service-based interface (SBI) or a point-to-point interface (e.g., F1-C). The first transport interface 704 may carry the communications between the UE and CS in a container and may include routing information related to the UE and CS. The communication between the eDU and a connection application of the UE may be carried on a second transport interface 712. The second transport interface 712 may carry the communications between the UE and CS in a container and may include routing information related to the UE and CS. The second transport interface 712 may include a signal radio bearer (SRB), data radio bearer (DRB), or an identifier (ID) on a L2 sublayer.

In some instances, a MS may communicate with a UE via an interface 706 (e.g., SBI or point-to-point interface). A third transport interface 708 may be utilized for communication between the MS and eDU. The eDU may comprise the interface 702 and 706. The third transport interface 708 may include SBI or a point-to-point interface. The third transport interface 708 may carry the communications between the UE and MS in a container and may include routing information related to the UE and MS. The communication between the eDU and the measurement application of the UE may be carried on a fourth transport interface 714. The fourth transport interface 714 may carry the communications between the UE and MS in a container and may include routing information related to the UE and MS. The fourth transport interface 714 may include a SRB, DRB, or an ID on a L2 sublayer. The eDU may provide separate mapping 710 for communication between the CS and UE (e.g., CS-eDU-UE-eDU) and for communication between the MS and the UE (e.g., MS-eDU-UE-eDU).

In some aspects, the UE may comprise or support a plurality of separate interfaces for different services. For example, the UE may support at least two separate interfaces, where a first interface is with a CS to obtain link configurations, and a second interface is with a MS to obtain measurement configurations and to send measurement reports. In some aspects, the first and second interfaces may include point-to-point interfaces and/or service-based interfaces. The interfaces may have an association, where the association is between UE and CS and may be initiated by the UE (e.g., RRC Setup Request). The association between UE and MS may be initiated by the MS based at least on the MS sending a measurement configuration. The interface with the MS may be released in response to or in addition with the release of the interface of the CS. In some aspects, the interface with the MS may be migrated to a new MS (e.g., a target MS) in response to the UE receiving a new measurement configuration from the target MS. In some aspects, the UE may be configured with a dedicated signaling channel on the radio interface for the plurality of interfaces. The signaling channels may refer to logical channels, radio bearers, or identifiers included on a sublayer or layer between UE and eDU. The signaling channels may be configured based on information received from the CS and/or the eDU. The UE may use a separate security keys for the security protection of each of these two interface and/or the corresponding signaling channels.

The eDU may have or support separate interfaces with the CS and with the MS. The interfaces may be point-to-point interfaces or service-based interfaces. In some aspects, the eDU may be configured with a dedicated signaling channel on the radio interface for each of the plurality of interfaces. The signaling channels may refer to logical channels, radio bearers, or identifiers included on a sublayer or layer between UE and eDU. For example, signaling channels may refer to identifiers such as logical channel ID (LCID), signaling/data radio bearer ID (SRB/DRB ID) or other identifiers on sublayers/layers, such as but not limited to identifier on RLC/MAC headers. In some aspects, separate identifiers may be utilized for eDU-MS and/or eDU-CS interfaces (e.g., LCID 1 for eDU-MS, LCID 2 for eDU-CS). In some aspects, the signaling channels may be configured by information received from the CS, while in some aspects, the eDU may configure the signaling channels. In some aspects, the eDU may perform data forwarding over one of the dedicated signaling channels via the interface with the CS. In some aspects, the eDU may perform data forwarding over other dedicated signaling channels via the interface with the MS. In some aspects, the eDU may selects the MS, and request that the MS provides the CS with measurement reports from the UE obtained by the MS. In some aspects, the request may be initiated by an establishment of the dedicated signaling channel for the association with the MS. In some aspects, the request may include at least an eDU ID, a UE ID, or a CS ID. In some aspects, the request may include the same UE ID as exchanged with the CS. In some aspects, the eDU may migrate the measurement support for a UE to a new MS (e.g., target MS) by requesting that the target MS provides measurement reports from the UE to a CS and canceling the delivery of measurement reports from the UE to the source MS.

In some aspects, the CS may be configured to select the MS. For example, the CS may select the MS and request that the MS provides the CS with the measurement reports from the UE obtained by the MS. The request may be initiated by the establishment of the dedicated signaling channel for the association with the MS. In some aspects, the request may include at least an eDU ID, a UE ID, or a CS ID. In some aspects, the request may include the same UE ID as exchanged with the eDU. The request may include a security key for the protection of signaling between the MS and UE. In some aspects, the CS may initiate a UE handover, from a source eDU to a target eDU, based on a measurement report received from the MS. In such instances, upon the completion of the UE handover, the CS may update the MS with the UE's target eDU ID. In some aspects, after releasing the connection of the UE or after receiving an indication regarding the release of the UE's context (e.g., after an inter-CS UE handover), the CS may indicate or inform the MS to cancel the delivery of the measurement reports from the UE. In some aspects, the CS may migrate the measurement support for a UE to a new MS (e.g., target MS) by requesting that the target MS provides measurement reports from the UE to a CS and canceling the delivery of measurement reports from the UE to the source MS.

In some aspects, the MS, upon receiving a request, from either the eDU or CS, to provide measurement reports from a UE, the MS may provide a message to the UE's eDU containing a measurement configuration for the UE. Upon receipt of a measurement report from the UE, the MS may forward the measurement report to the CS or eDU. The request for measurement reports may include a UE ID and/or an eDU ID. The request may include the UE ID within the message to the eDU carrying the measurement configuration. In some aspects, the measurement report may be carried in a message from the eDU together with the UE ID. In some aspects, the MS may also receive a security key from the CS which the MS may utilize to protect the signaling with the UE. In some aspects, the MS may establish an association with the UE via a point-to-point connection or an SBI. In some aspects, the MS may include the UE ID when forwarding the measurement report to the CS or eDU. In some aspects, the MS may receive a request to provide measurement reports from UEs without a UE ID. In such instances, the MS may forward the measurement report without including a UE ID. In such instances, the MS may expose a first API for the requests of measurement reports with respect to a UE and a second API for the request of measurement reports without reference to a specific UE. In some aspects, the MS may receive information about neighbor relations of cells and may derive at least part of the measurement configuration for the UE based on the information about the neighbor relations of the cells. The MS may receive the information about the neighbor relations of the cells based on a request from the eDU or CS. The MS may expose an API to receive the information about the neighbor relations of the cells. In some aspects, the MS may receive a request, from the CS or the eDU, to discontinue sending measurement reports from the UE. The MS, in response to such request, may send the information to the UE to discontinue reporting measurements. In such instances, the MS may remove or release the association with the UE.

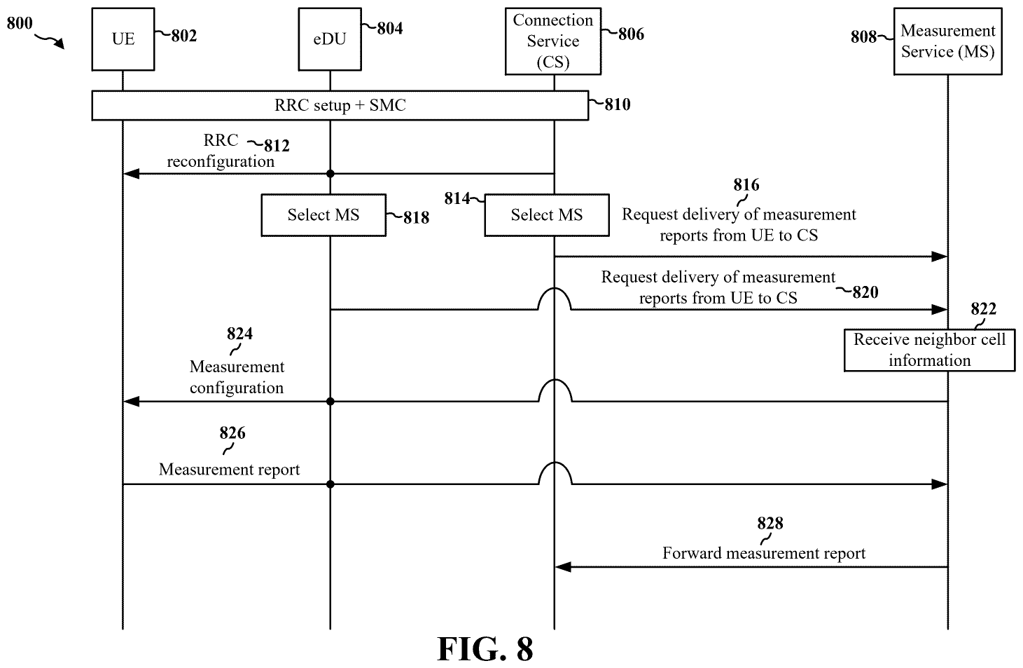

FIG. 8 is a diagram 800 illustrating an example of a UE access procedure. The diagram 800 includes a UE 802, an eDU 804, a CS 806, and an MS 808. At 810, the UE may establish a connection with the CS 806. The UE may then establish an RRC connection. Also at 810, a security mode command (SMC) and related signaling may be exchanged. At 812, the CS 806 may provide an RRC reconfiguration to the UE 802. The UE 802 may receive the RRC reconfiguration from the CS 806. The RRC reconfiguration may lack a measurement configuration. The RRC reconfiguration may include a configuration of a channel for signaling between the MS and UE. A transport for communication between the CS and eDU may include a container with the RRC reconfiguration.

At 814, the CS may select an MS. The CS, at 816, may then provide, to the MS 808, a request for delivery of measurement reports from the UE obtained by the MS. The request may include at least one of a UE ID, an eDU ID, a CS ID, or a security key for a wireless link. In some aspects, the CS does not select the MS. In such instances, the eDU, at 818, may select the MS. The eDU, at 820, may then provide, to the MS 808, a request for delivery of measurement reports, obtained by the MS, from the UE to the CS. The request may include at least one of a UE ID, an eDU ID, a CS ID, or a security key for a wireless link.

At 822, the MS 808 may receive neighbor cell information. The MS may receive information about neighbor relations of cells and may derive at least part of the measurement configuration for the UE based on the information about the neighbor relations of the cells. For example, the information about the neighbor relations of cells may include a policy or information that indicates that one or more cells that are unavailable, prohibited, or available for at least part of the measurement configuration for the UE. The information about the neighbor relations may be provided by a third party service (not shown). The MS may receive the information about the neighbor relations of the cells based on a request. The MS may expose an API to receive the information about the neighbor relations of the cells.

At 824, the MS 808 may provide a measurement configuration to the UE 802. The measurement configuration may include a security protection based on a key obtained by the MS from the CS. A transport for communication between the MS and eDU may include at least one of an MS ID, a UE ID, and a container with the measurement configuration. A channel may be utilized for signaling between the MS and UE.

At 826, the UE may transmit a measurement report to the MS. The measurement report may include a security protection based on the key provided by the MS, where the MS obtained the key from the CS. The channel may be utilized for signaling between the MS and UE. The transport for communication between the MS and eDU may include at least one of the MS ID, the UE ID, and the container with the measurement report.

At 828, the MS may forward the measurement report from the UE. The MS may forward the measurement report, obtained from the UE, to the CS. The measurement report may include at least one of the UE ID, the MS ID, or the CS ID.

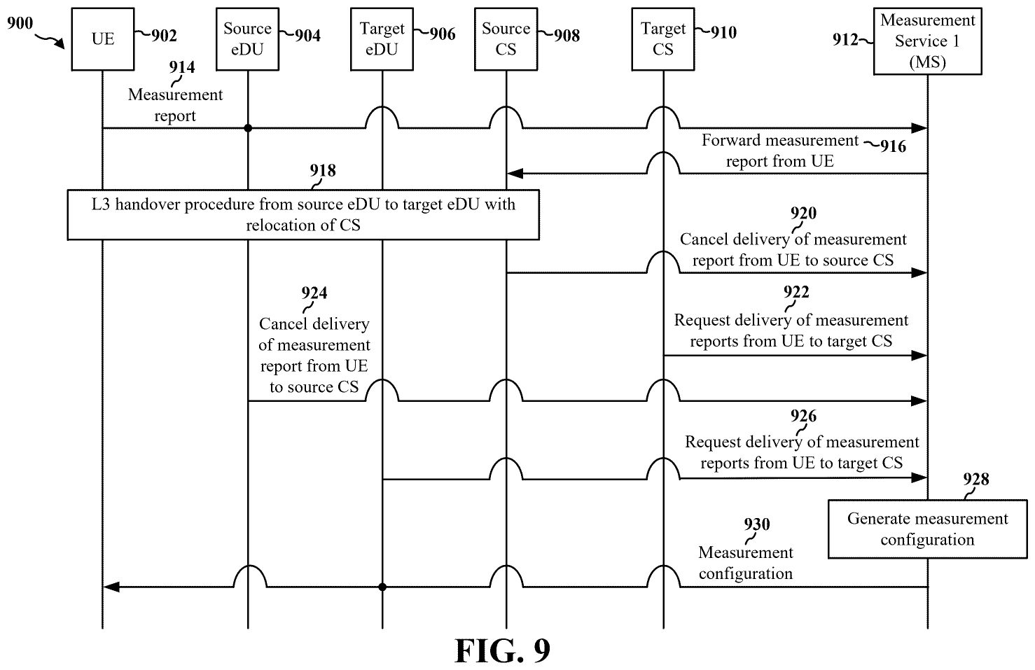

FIG. 9 is a diagram 900 illustrating an example of a L3 handover. The diagram 900 includes a UE 902, a source eDU 904, a target eDU 906, a source CS 908, a target CS 910, and a MS 912. At 914, the UE 902 may transmit a measurement report to the MS 912. The UE 902 is configured similarly as the UE 802, such that transmission of the measurement report occurs in a similar manner. At 916, the MS 912 may then forward the measurement report to the source CS 908.

At 918, an L3 handover procedure may occur, where the L3 handover procedure is a handover from the source eDU to the target eDU with a relocation of the CS. An RRC reconfiguration may occur during the L3 handover procedure, as discussed in the aspect of diagram 800 of FIG. 8.

At 920, the source CS 908 may indicate the MS 912 to cancel delivery of the measurement reports obtained by the MS 912 from the UE 902 and forwarded by the MS 912 to the source CS. The target CS 910 may provide a request, to the MS 912, for delivery of the measurement reports from the UE. At 922, the target CS may provide a request to the MS 912 to deliver or forward the measurement reports obtained by the UE to the target CS. The request for delivery of the measurement reports provided to the MS from the target CS may be similar, as discussed in the aspect of diagram 800 of FIG. 8. In some aspects, the source eDU 904, instead of the source CS 908, may initiate the cancellation of delivery of the measurement reports to the source CS. In such instances, the source eDU 904, at 924, may indicate to the MS 912 to cancel delivery of the measurement reports obtained by the MS 912 from the UE 902 and forwarded by the MS 912 to the source CS. The target eDU 906, at 926, may then provide a request to the MS 912 to deliver or forward the measurement reports obtained from the UE to the target CS. The request for delivery of the measurement reports provided to the MS from the target eDU may be similar, as discussed in the aspect of diagram 800 of FIG. 8.

At 928, the MS 912 may generate a measurement configuration. The MS 912, at 930, may provide the measurement configuration to the UE 902. The measurement configuration may include a security protection based on a key obtained by the MS from the source CS 908 or the target CS 910. A transport for communication between the MS and eDU (e.g., source eDU 904, target eDU 906) may include at least one of an MS ID, a UE ID, and a container with the measurement configuration. A channel may be utilized for signaling between the MS and UE.

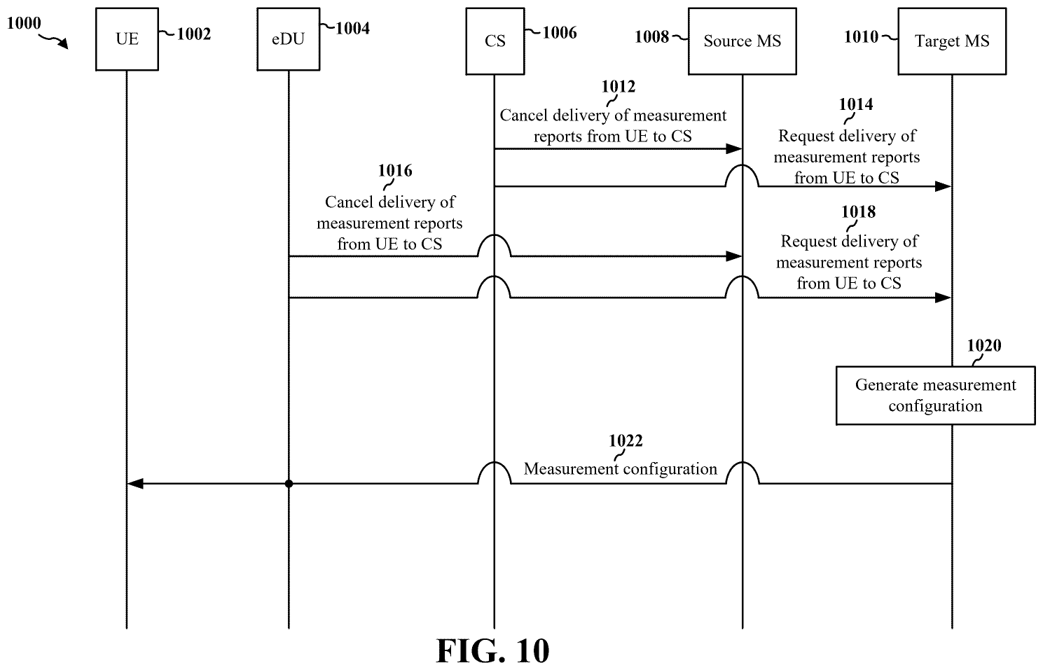

FIG. 10 is a diagram 1000 illustrating an example of a relocation of a MS. The diagram 1000 includes a UE 1002, an eDU 1004, a CS 1006, a source MS 1008, and a target MS 1010. At 1012, the CS 1006 may cancel delivery of measurement reports obtained by the source MS 1008 from the UE 1002 in a similar manner as discussed in the example of FIG. 9. The CS 1006, at 1014, may then provide a request, to the target MS 1010, for delivery of the measurement reports from the UE 1002 to the CS 1006. The request for delivery of the measurement reports provided to the target MS from the CS may be similar, as discussed in the aspect of diagram 800 of FIG. 8 or diagram 900 of FIG. 9. In some aspects, the eDU 1004, instead of the CS 1006, may initiate the cancellation of delivery of the measurement reports to the CS 1006. In such instances, the eDU 1004, at 1016, may indicate to the source MS 1008 to cancel delivery of the measurement reports obtained from the UE 1002 and forwarded by the source MS 1008 to the CS 1006. The eDU 1004, at 1018, may then provide a request to the target MS 1010 to deliver or forward the measurement reports, obtained from the UE 1002, to the CS 1006. The request for delivery of the measurement reports provided to the target MS from the eDU 1004 may be similar, as discussed in the aspect of diagram 800 of FIG. 8 or diagram 900 of FIG. 9.

At 1020, the target MS 1010 may generate a measurement configuration. The target MS 1010, at 1022, may provide the measurement configuration to the UE 1002. The measurement configuration may include a security protection based on a key obtained by the target MS from the CS. A transport for communication between the MS (e.g., source MS 1008, target MS 1010) and the eDU may include at least one of an MS ID, a UE ID, and a container with the measurement configuration. A channel may be utilized for signaling between the target MS and UE.

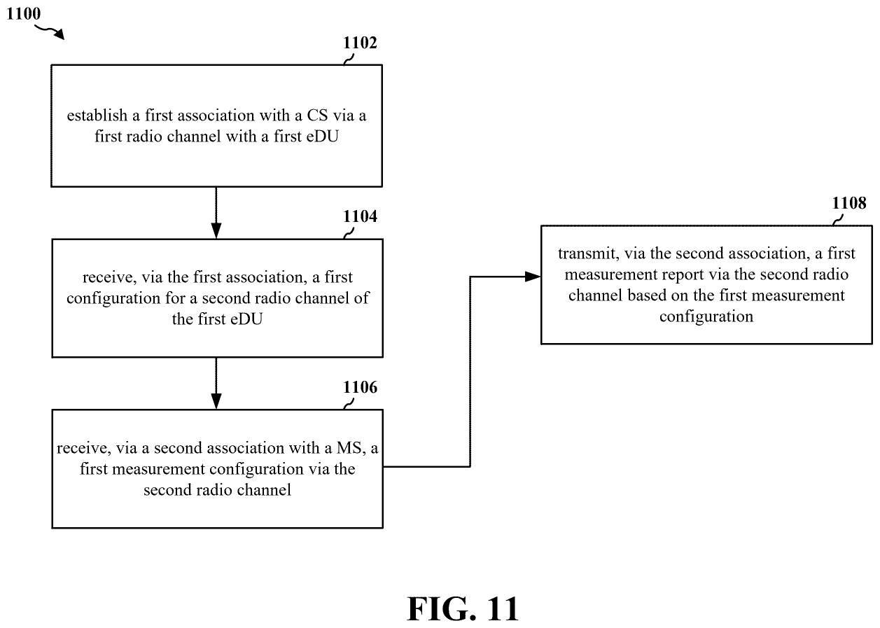

FIG. 11 is a flowchart 1100 of a method of wireless communication at a UE. The method may be performed by a UE (e.g., the UE 104; the apparatus 1304). One or more of the illustrated operations may be omitted, transposed, or contemporaneous. The method may allow a UE to establish multiple associations to communicate with separate logical entities.

At 1102, the UE may establish a first association with a CS. For example, 1102 may be performed by configuration component 198 of apparatus 1304. The UE may establish the first association with the CS via a first radio channel with a first eDU. In some aspects, the UE may comprise, or support, a first interface to establish the first association with the CS and a second interface to establish a second association with a MS. The interface may include a point-to-point interface (e.g., that supports RRC or lower layer signaling such as MAC-CE, DCI) or a service-based interface (e.g., application programming interface). In some aspects, the first interface may support reception of link configurations. In some aspects, the second interface may support reception of measurement configurations and transmission of measurement reports. In some aspects, a dedicated radio channel may be configured for each of the first interface and the second interface. The dedicated radio channel may correspond to at least one of a logical channel, a radio bearer, or an identifier included on a sublayer or layer between the UE and the first eDU.

At 1104, the UE may receive a first configuration for a second radio channel. For example, 1104 may be performed by configuration component 198 of apparatus 1304. The UE may receive the first configuration for the second radio channel via the first association. The UE may receive the first configuration for the second radio channel of the first eDU.

At 1106, the UE may receive a first measurement configuration. For example, 1106 may be performed by configuration component 198 of apparatus 1304. The UE may receive, via a second association with a MS, the first measurement configuration. The UE may receive the first measurement configuration via the second radio channel.

At 1108, the UE may transmit a first measurement report via the second radio channel. For example, 1108 may be performed by configuration component 198 of apparatus 1304. The UE may transmit, via the second association, the first measurement report. The UE may transmit the first measurement report via the second radio channel based on the first measurement configuration.

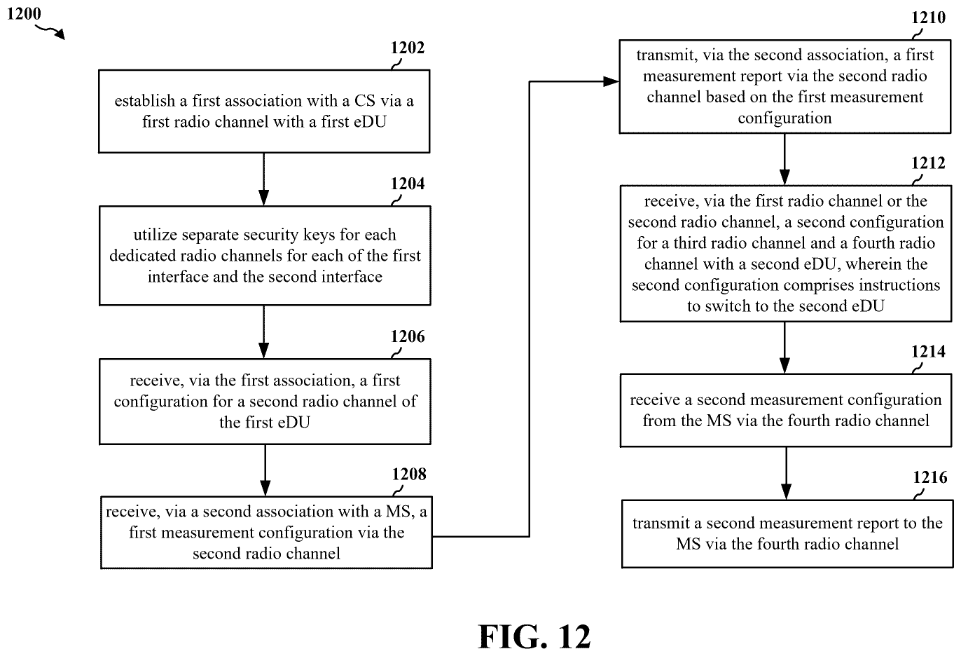

FIG. 12 is a flowchart 1200 of a method of wireless communication at a UE. The method may be performed by a UE (e.g., the UE 104; the apparatus 1304). One or more of the illustrated operations may be omitted, transposed, or contemporaneous. The method may allow a UE to establish multiple associations to communicate with separate logical entities.

At 1202, the UE may establish a first association with a CS. For example, 1202 may be performed by configuration component 198 of apparatus 1304. The UE may establish the first association with the CS via a first radio channel with a first eDU. In some aspects, the UE may comprise, or support, a first interface to establish the first association with the CS and a second interface to establish a second association with a MS. The interface may include a point-to-point interface (e.g., that supports RRC or lower layer signaling such as MAC-CE, DCI) or a service-based interface (e.g., application programming interface). In some aspects, the first interface may support reception of link configurations. In some aspects, the second interface may support reception of measurement configurations and transmission of measurement reports. In some aspects, a dedicated radio channel may be configured for each of the first interface and the second interface. The dedicated radio channel may correspond to at least one of a logical channel, a radio bearer, or an identifier included on a sublayer or layer between the UE and the first eDU.

At 1204, the UE may utilize separate security keys for each dedicated radio channels. For example, 1204 may be performed by configuration component 198 of apparatus 1304. The UE may utilize the separate security keys for each dedicated radio channels for each of the first interface and the second interface.

At 1206, the UE may receive a first configuration for a second radio channel. For example, 1206 may be performed by configuration component 198 of apparatus 1304. The UE may receive the first configuration for the second radio channel via the first association. The UE may receive the first configuration for the second radio channel of the first eDU.

At 1208, the UE may receive a first measurement configuration. For example, 1208 may be performed by configuration component 198 of apparatus 1304. The UE may receive, via a second association with a MS, the first measurement configuration. The UE may receive the first measurement configuration via the second radio channel.

At 1210, the UE may transmit a first measurement report via the second radio channel. For example, 1210 may be performed by configuration component 198 of apparatus 1304. The UE may transmit, via the second association, the first measurement report. The UE may transmit the first measurement report via the second radio channel based on the first measurement configuration.

At 1212, the UE may receive a second configuration for a third radio channel and a fourth radio channel with a second eDU. For example, 1212 may be performed by configuration component 198 of apparatus 1304. The UE may receive, via the first radio channel or the second radio channel, the second configuration for the third radio channel and the fourth radio channel with the second eDU. The second configuration may include instructions to switch to the second eDU. In some aspects, the third radio channel may be for communication with the CS and the fourth radio channel may be for communication with a MS.

At 1214, the UE may receive a second measurement configuration. For example, 1214 may be performed by configuration component 198 of apparatus 1304. The UE may receive the second measurement configuration from a MS. The UE may receive the second measurement configuration from the MS via the fourth radio channel. At 1216, the UE may transmit a second measurement report. For example, 1216 may be performed by configuration component 198 of apparatus 1304. The UE may transmit the second measurement report to the MS. The UE may transmit the second measurement report to the MS via the fourth radio channel.

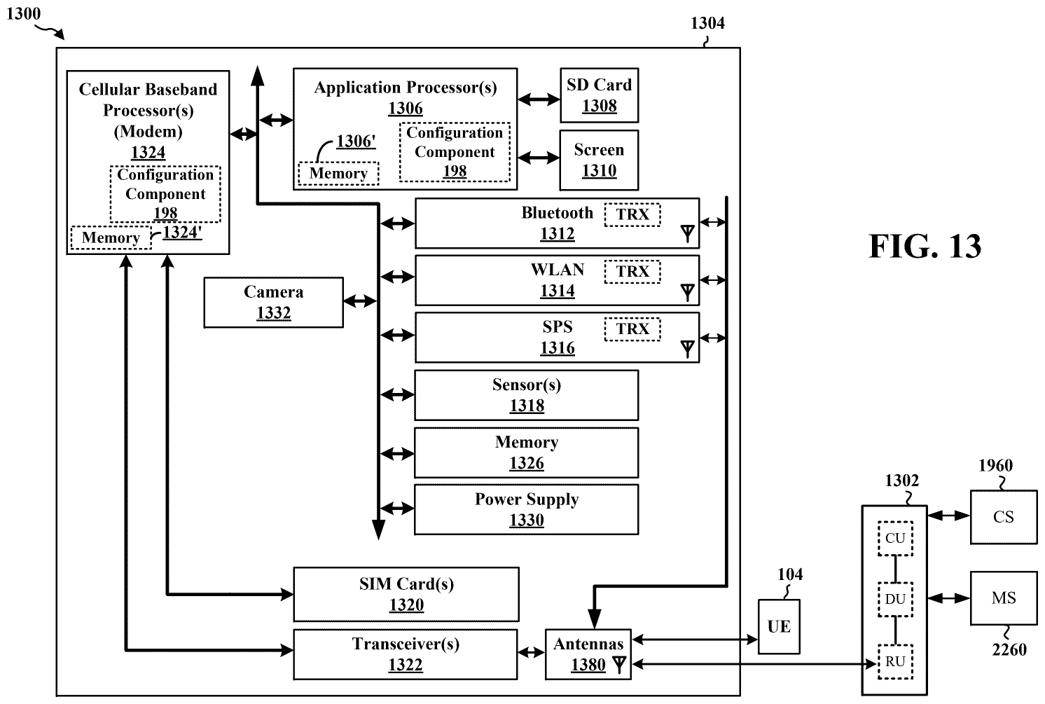

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory (e.g., 1324′, 1306′, 1326) may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the component 198 may be configured to establish a first association with a CS via a first radio channel with a first eDU; receive, via the first association, a first configuration for a second radio channel of the first eDU; receive, via a second association with a MS, a first measurement configuration via the second radio channel; and transmit, via the second association, a first measurement report via the second radio channel based on the first measurement configuration. The component 198, and or the apparatus 1304, may be further configured to perform any of the aspects described in connection with the flowcharts in any of FIG. 11 or 12, and/or performed by the UE in the communication flow in any of FIGS. 8-10. The component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for establishing a first association with a CS via a first radio channel with a first eDU. The apparatus includes means for receiving, via the first association, a first configuration for a second radio channel of the first eDU. The apparatus includes means for receiving a first measurement configuration via the second radio channel. The apparatus includes means for transmitting a first measurement report via the second radio channel based on the first measurement configuration. The apparatus further includes means for receiving, via the first radio channel or the second radio channel, a second configuration for a third radio channel and a fourth radio channel with a second eDU, wherein the second configuration comprises instructions to switch to the second eDU. The apparatus further includes means for receiving a second measurement configuration from a MS via the fourth radio channel. The apparatus further includes means for transmitting a second measurement report to the MS via the fourth radio channel. The apparatus further includes means for utilizing separate security keys for each dedicated radio channels for each of the first interface and the second interface. The apparatus 1304 means for performing any of the aspects described in connection with the flowcharts in any of FIG. 11 or 12, and/or performed by the UE in the communication flow in any of FIGS. 8-10. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

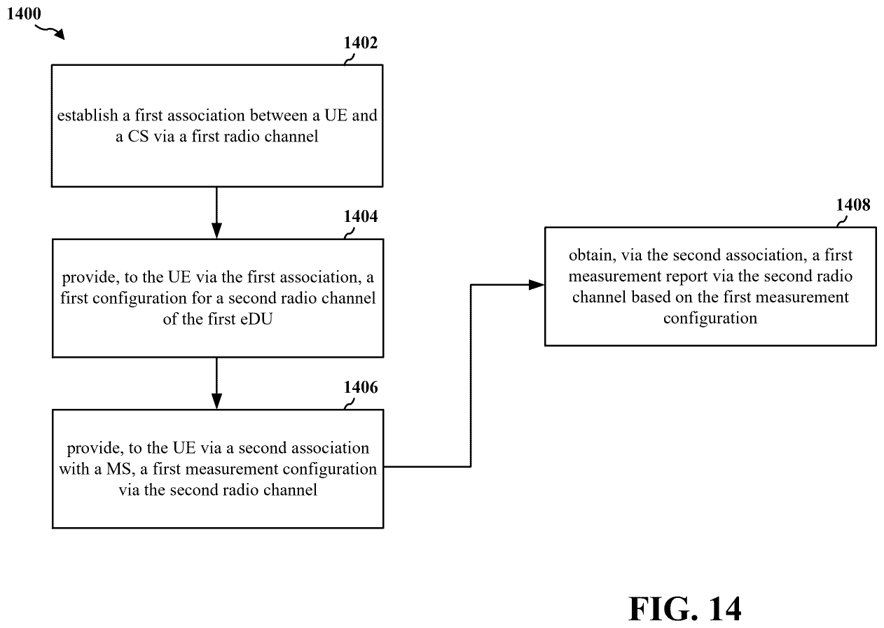

FIG. 14 is a flowchart 1400 of a method of wireless communication at a network entity. The method may be performed by a network entity (e.g., the base station 102; the network entity 1602). In some instances, the network entity may include an eDU. One or more of the illustrated operations may be omitted, transposed, or contemporaneous. The method may allow a network entity to establish multiple associations to communicate with separate logical entities.

At 1402, the first eDU may establish a first association between a UE and a CS. For example, 1402 may be performed by configuration component 199 of network entity 1602. The first eDU may establish the first association between the UE and the CS via a first radio channel. In some aspects, the first eDU includes, or supports, a first interface to communicate with the CS and a second interface to communicate with a MS. A dedicated radio channel may be configured for each of the first interface and the second interface. The dedicated radio channel may correspond to at least one of logical channels, radio bearers, or identifiers included on a sublayer or layer between the UE and the first eDU. In some aspects, data may be forwarded over a first dedicated radio channel via the first interface to the CS. Data may be forwarded over a second dedicated radio channel via the second interface to the MS. In some aspects, selection of the MS may be selected by the first eDU. The MS may be provided with a request to provide the CS with the first measurement report for the UE. In some aspects, the request may be provided in response to an establishment of a dedicated radio channel for an association with the MS. In some aspects, the request comprises an eDU identifier (ID), a UE ID, and a CS ID. The ID may correspond to a fully qualified domain name (FQDN), IP address, or the like.

At 1404, the first eDU may provide a first configuration for a second radio channel of the first eDU. For example, 1404 may be performed by configuration component 199 of network entity 1602. The first eDU may provide, to the UE via the first association, the first configuration for the second radio channel of the first eDU. The first eDU may obtain the first configuration from the CS.

At 1406, the first eDU may provide a first measurement configuration. For example, 1406 may be performed by configuration component 199 of network entity 1602. The first eDU may provide, to the UE via a second association with a MS, the first measurement configuration via the second radio channel. The first eDU may obtain the first measurement configuration from the MS.

At 1408, the first eDU may obtain a first measurement report. For example, 1408 may be performed by configuration component 199 of network entity 1602. The first eDU may obtain, via the second association, the first measurement report via the second radio channel. The first eDU may obtain the first measurement report via the second radio channel based on the first measurement configuration.

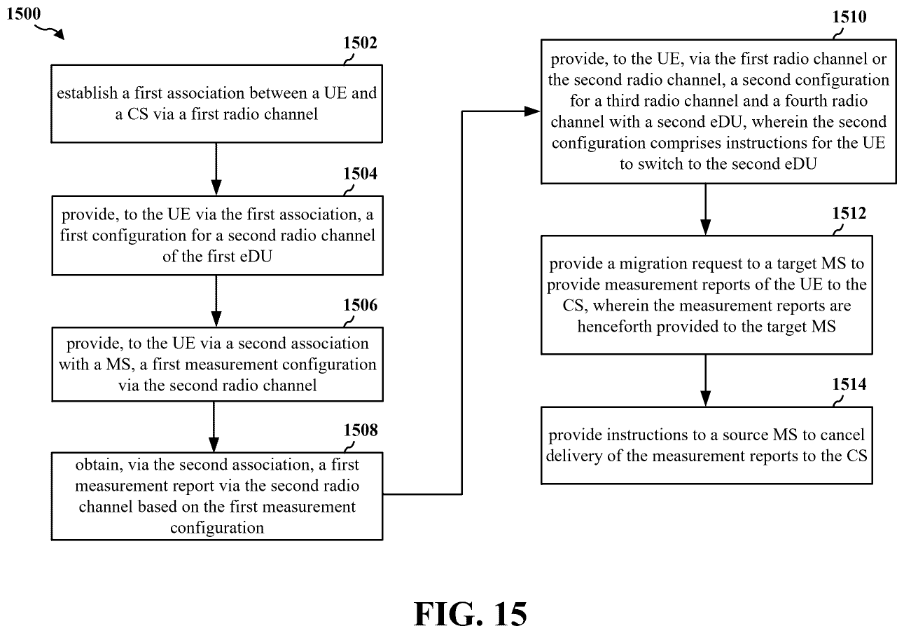

FIG. 15 is a flowchart 1500 of a method of wireless communication at a network entity. The method may be performed by a base station (e.g., the base station 102; the network entity 1602). In some instances, the network entity may include an eDU. One or more of the illustrated operations may be omitted, transposed, or contemporaneous. The method may allow a network entity to establish multiple associations to communicate with separate logical entities.

At 1502, the first eDU may establish a first association between a UE and a CS. For example, 1402 may be performed by configuration component 199 of network entity 1602. The first eDU may establish the first association between the UE and the CS via a first radio channel. In some aspects, the first eDU includes, or supports, a first interface to communicate with the CS and a second interface to communicate with a MS. A dedicated radio channel may be configured for each of the first interface and the second interface. The dedicated radio channel may correspond to at least one of logical channels, radio bearers, or identifiers included on a sublayer or layer between the UE and the first eDU. In some aspects, data may be forwarded over a first dedicated radio channel via the first interface to the CS. Data may be forwarded over a second dedicated radio channel via the second interface to the MS. In some aspects, selection of the MS may be selected by the first eDU. The MS may be provided with a request to provide the CS with the first measurement report for the UE. In some aspects, the request may be provided in response to an establishment of a dedicated radio channel for an association with the MS. In some aspects, the request comprises an eDU ID, a UE ID, and a CS ID. The ID may correspond to a FQDN, IP address, or the like.

At 1504, the first eDU may provide a first configuration for a second radio channel of the first eDU. For example, 1404 may be performed by configuration component 199 of network entity 1602. The first eDU may provide, to the UE via the first association, the first configuration for the second radio channel of the first eDU. The first eDU may obtain the first configuration from the CS.

At 1506, the first eDU may provide a first measurement configuration. For example, 1406 may be performed by configuration component 199 of network entity 1602. The first eDU may provide, to the UE via a second association with a MS, the first measurement configuration via the second radio channel. The first eDU may obtain the first measurement configuration from the MS.

At 1508, the first eDU may obtain a first measurement report. For example, 1508 may be performed by configuration component 199 of network entity 1602. The first eDU may obtain, via the second association, the first measurement report via the second radio channel. The first eDU may obtain the first measurement report via the second radio channel based on the first measurement configuration.

At 1510, the first eDU may provide a second configuration for a third radio channel and a fourth radio channel with a second eDU. For example, 1510 may be performed by configuration component 199 of network entity 1602. The first eDU may provide, via the first radio channel or the second radio channel, the second configuration for the third radio channel and the fourth radio channel with the second eDU. In some aspects, the second configuration may include instructions for the UE to switch to the second eDU.

At 1512, the first eDU may provide a migration request to a target MS. For example, 1512 may be performed by configuration component 199 of network entity 1602. The first eDU may provide the migration request to the target MS to provide measurement reports of the UE to the CS. In some aspects, the measurement reports are henceforth provided to the target MS, in response to the migration request.

At 1514, the first eDU may provide instructions to a source MS to cancel delivery of the measurement reports. For example, 1514 may be performed by configuration component 199 of network entity 1602. The first eDU may provide instructions to the source MS to cancel delivery of the measurement reports to the CS.

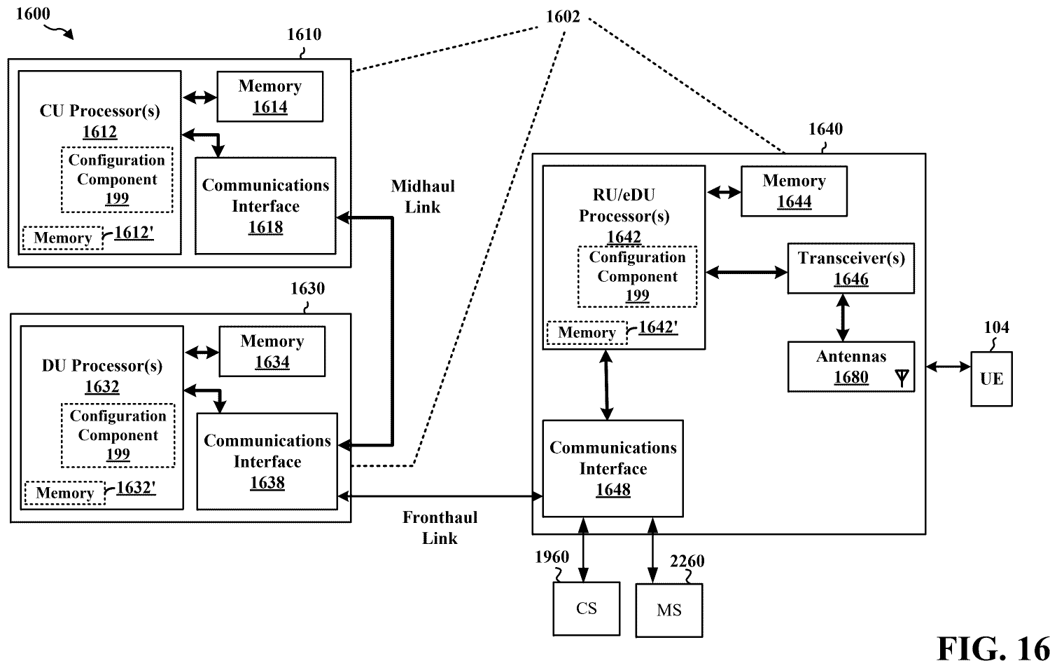

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to establish a first association between a UE and a CS via a first radio channel; provide, to the UE via the first association, a first configuration for a second radio channel of the first eDU; provide, to the UE via a second association with a MS, a first measurement configuration via the second radio channel; and obtain, via the second association, a first measurement report via the second radio channel based on the first measurement configuration. The component 199, and or the network entity 1602, may be further configured to perform any of the aspects described in connection with the flowcharts in any of FIG. 14 or 15, and/or performed by an eDU in the communication flow in any of FIGS. 8-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for establishing a first association between a UE and a CS via a first radio channel. The network entity includes means for providing, to the UE via the first association, a first configuration for a second radio channel of the first eDU. The network entity includes means for providing, to the UE, a first measurement configuration via the second radio channel. The network entity includes means for obtaining a first measurement report via the second radio channel based on the first measurement configuration. The network entity further includes means for providing, via the first radio channel or the second radio channel, a second configuration for a third radio channel and a fourth radio channel with a second eDU, wherein the second configuration comprises instructions for the UE to switch to the second eDU. The network entity further includes means for providing a migration request to a target MS to provide measurement reports of the UE to the CS, wherein the measurement reports are henceforth provided to the target MS. The network entity further includes means for providing instructions to a source MS to cancel delivery of the measurement reports to the CS. The network entity 1602 may further include means for performing any of the aspects described in connection with the flowcharts in any of FIG. 14 or 15, and/or performed by an eDU in the communication flow in any of FIGS. 8-10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

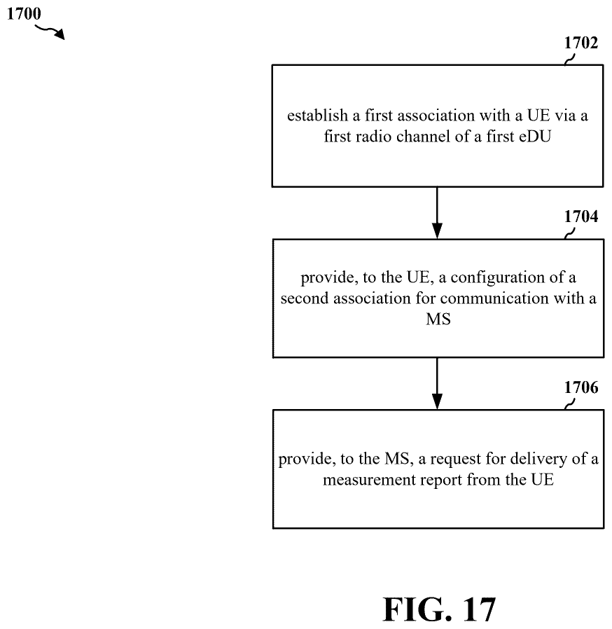

FIG. 17 is a flowchart 1700 of a method of wireless communication at a network entity. The method may be performed by a network entity (e.g., the base station 102; the network entity 1960). In some aspects, the network entity may include the CS. One or more of the illustrated operations may be omitted, transposed, or contemporaneous. The method may allow a network entity to establish an association to communicate with a UE regarding connection control functions.

At 1702, the CS may establish a first association with a UE. For example, 1702 may be performed by configuration component 1916 of network entity 1960. The CS may establish the first association with the UE via a first radio channel with a first eDU.

At 1704, the CS may provide a configuration of a second association for communication with a MS. For example, 1704 may be performed by configuration component 1916 of network entity 1960. The CS may provide, to the UE, the configuration of the second association for communication with the MS.

At 1706, the CS may provide a request for delivery of a measurement report from the UE. For example, 1706 may be performed by configuration component 1916 of network entity 1960. The CS may provide, to the MS, a request for delivery of a measurement report from the UE. In some aspects, the request for the delivery of the measurement report is provided to the MS. The request may include at least one of a UE ID, an eDU ID, a CS ID, or a security key for communication between the MS and UE.

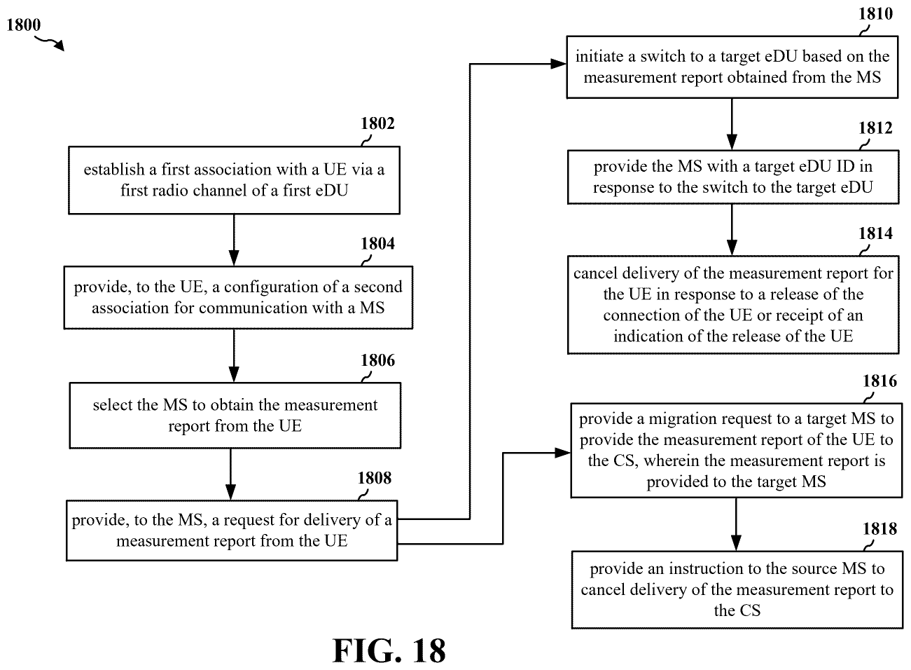

FIG. 18 is a flowchart 1800 of a method of wireless communication at a network entity. The method may be performed by a base station (e.g., the base station 102; the network entity 1960). In some aspects, the network entity may include the CS. One or more of the illustrated operations may be omitted, transposed, or contemporaneous. The method may allow a network entity to establish an association to communicate with a UE regarding connection control functions.

At 1802, the CS may establish a first association with a UE. For example, 1802 may be performed by configuration component 1916 of network entity 1960. The CS may establish the first association with the UE via a first radio channel with a first eDU.

At 1804, the CS may provide a configuration of a second association for communication with a MS. For example, 1804 may be performed by configuration component 1916 of network entity 1960. The CS may provide, to the UE, the configuration of the second association for communication with the MS.

At 1806, the CS may select the MS. For example, 1806 may be performed by configuration component 1916 of network entity 1960. The CS may select the MS to obtain the measurement report from the UE.

At 1808, the CS may provide a request for delivery of a measurement report from the UE. For example, 1808 may be performed by configuration component 1916 of network entity 1960. The CS may provide, to the MS, a request for delivery of a measurement report from the UE. In some aspects, the request for the delivery of the measurement report is provided to the MS. The request may include at least one of a UE ID, an eDU ID, a CS ID, or a security key for communication between the MS and UE.

At 1810, the CS may initiate a switch to a target eDU. For example, 1810 may be performed by configuration component 1916 of network entity 1960. The CS may initiate the switch to the target eDU based on the measurement report obtained from the MS.

At 1812, the CS may provide the MS with a target eDU ID. For example, 1812 may be performed by configuration component 1916 of network entity 1960. The CS may provide the MS with the target eDU ID in response to the switch to the target eDU.

At 1814, the CS may cancel delivery of the measurement report for the UE. For example, 1814 may be performed by configuration component 1916 of network entity 1960. The CS may cancel the delivery of the measurement report for the UE in response to a release of the connection of the UE or receipt of an indication of the release of the UE.

At 1816, the CS may provide a migration request to a target MS. For example, 1816 may be performed by configuration component 1916 of network entity 1960. The CS may provide the migration request to the target MS to provide the measurement report of the UE to the CS. In some aspects, the measurement report may be provided to the target MS.

At 1818, the CS may provide an instruction to the source MS to cancel delivery of the measurement report. For example, 1818 may be performed by configuration component 1916 of network entity 1960. The CS may provide the instruction to the source MS to cancel the delivery of the measurement report to the CS.

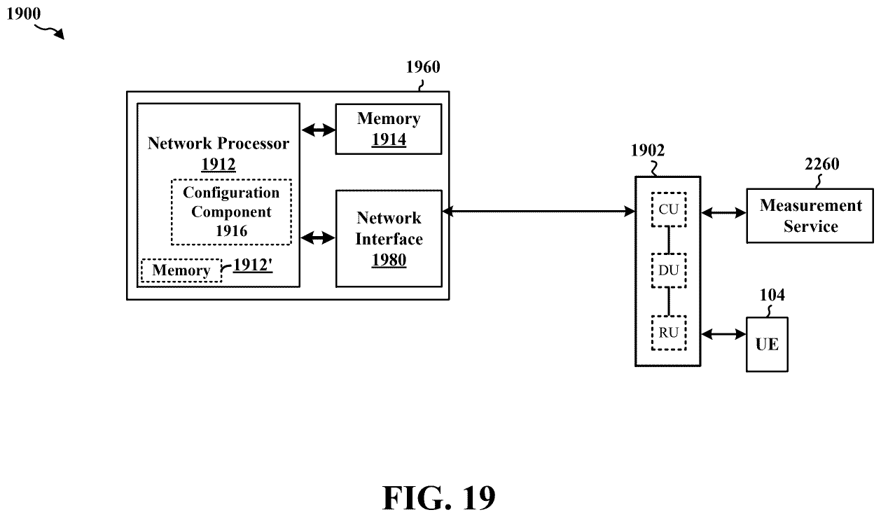

FIG. 19 is a diagram 1900 illustrating an example of a hardware implementation for a network entity 1960. In one example, the network entity 1960 may be within the core network 120. The network entity 1960 may include at least one network processor 1912. The network processor(s) 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The network processor(s) 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 1916 may be configured to establish a first association with a UE via a first radio channel with a first eDU; provide, to the UE, a configuration of a second association for communication with a MS; and provide, to the MS, a request for delivery of a measurement report from the UE. The component 1916, and or the network entity 1960, may be further configured to perform any of the aspects described in connection with the flowcharts in any of FIG. 17 or 18, and/or performed by an CS in the communication flow in any of FIGS. 8-10. The component 1916 may be within the network processor(s) 1912. The component 1916 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1960 may include a variety of components configured for various functions. In one configuration, the network entity 1960 may include means for establishing a first association with a UE via a first radio channel with a first eDU. The network entity includes means for providing, to the UE, a configuration of a second association for communication with a MS. The network entity includes means for providing, to the MS, a request for delivery of a measurement report from the UE. The network entity further includes means for selecting the MS to obtain the measurement report from the UE. The network entity further includes means for initiating a switch to a target eDU based on the measurement report obtained from the MS. The network entity further includes means for providing the MS with a target eDU ID in response to the switch to the target eDU. The network entity further includes means for cancelling delivery of the measurement report for the UE in response to a release of the connection of the UE or receipt of an indication of the release of the UE. The network entity further includes means for providing a migration request to a target MS to provide the measurement report of the UE to the CS, wherein the measurement report is provided to the target MS. The network entity further includes means for providing an instruction to the source MS to cancel delivery of the measurement report to the CS. The network entity 1960 may further include means for performing any of the aspects described in connection with the flowcharts in any of FIG. 17 or 18, and/or performed by an CS in the communication flow in any of FIGS. 8-10. The means may be the component 1916 of the network entity 1960 configured to perform the functions recited by the means.

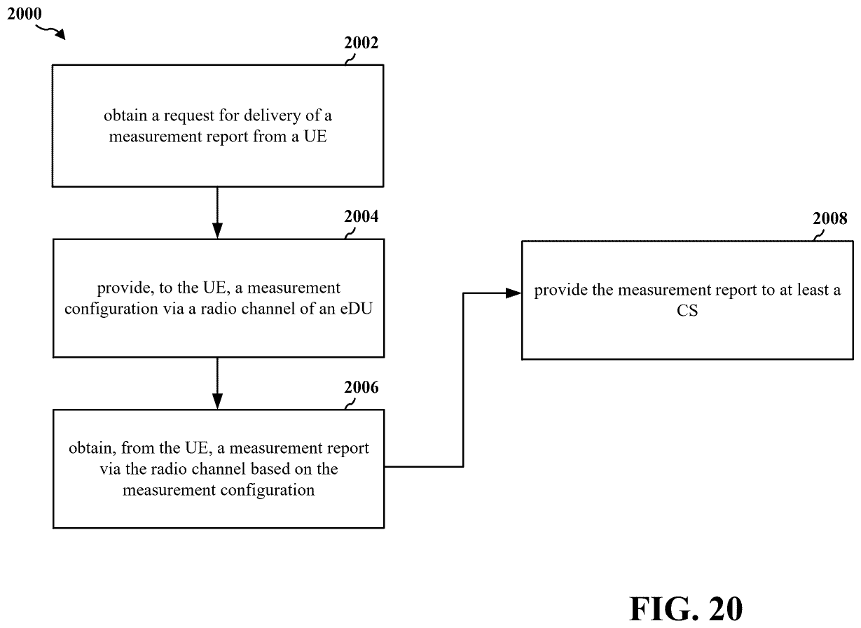

FIG. 20 is a flowchart 2000 of a method of wireless communication at a MS. The method may be performed by a network entity (e.g., the network entity 2260). In some aspects, the network entity may include the MS. One or more of the illustrated operations may be omitted, transposed, or contemporaneous. The method may allow a network entity to establish an association to communicate with a UE regarding measurement control functions.

At 2002, the MS may obtain a request for delivery of a measurement report. For example, 2002 may be performed by configuration component 2216 of network entity 2260. The MS may obtain the request for the delivery of the measurement report from a UE. In some aspects, the request may include at least one of a UE ID, an eDU ID, a CS ID, or a security key for communication between the MS and UE. In some aspects, the request may be obtained from the CS or the eDU. In some aspects, the request for the measurement report may include, or indicate, a request without reference to the UE.

At 2004, the MS may provide a measurement configuration via a radio channel. For example, 2004 may be performed by configuration component 2216 of network entity 2260. The MS may provide, to the UE, the measurement configuration via the radio channel of an eDU.

At 2006, the MS may obtain a measurement report. For example, 2006 may be performed by configuration component 2216 of network entity 2260. The MS may obtain, from the UE, the measurement report via the radio channel based on the measurement configuration.

At 2008, the MS may provide the measurement report to the CS. For example, 2008 may be performed by configuration component 2216 of network entity 2260.

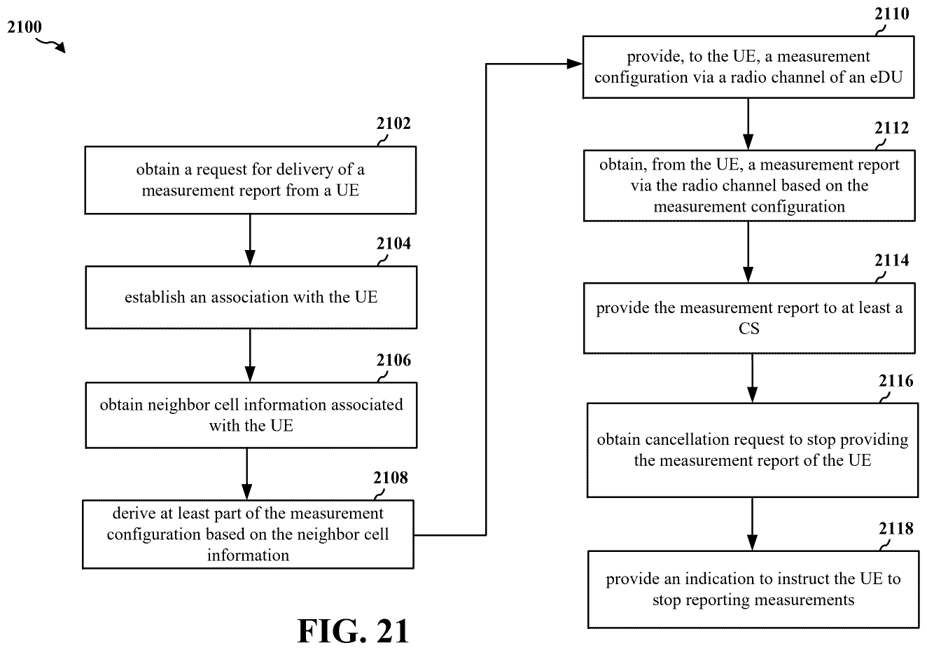

FIG. 21 is a flowchart 2100 of a method of wireless communication at a MS. The method may be performed by a base station (e.g., the network entity 2260). In some aspects, the network entity may include the MS. One or more of the illustrated operations may be omitted, transposed, or contemporaneous. The method may allow a network entity to establish an association to communicate with a UE regarding measurement control functions.

At 2102, the MS may obtain a request for delivery of a measurement report. For example, 2002 may be performed by configuration component 2216 of network entity 2260. The MS may obtain the request for the delivery of the measurement report from a UE. In some aspects, the request may include at least one of a UE ID, an eDU ID, a CS ID, or a security key for communication between the MS and UE. In some aspects, the request may be obtained from the CS or the eDU. In some aspects, the request for the measurement report may include, or indicate, a request without reference to the UE.

At 2104, the MS may establish an association with the UE. For example, 2104 may be performed by configuration component 2216 of network entity 2260.

At 2106, the MS may obtain neighbor cell information. For example, 2106 may be performed by configuration component 2216 of network entity 2260. The MS may obtain the neighbor cell information associated with the UE.

At 2108, the MS may derive at least part of the measurement configuration. For example, 2108 may be performed by configuration component 2216 of network entity 2260. The MS may derive at least part of the measurement configuration based on the neighbor cell information.

At 2110, the MS may provide a measurement configuration via a radio channel. For example, 2110 may be performed by configuration component 2216 of network entity 2260. The MS may provide, to the UE, the measurement configuration via the radio channel of an eDU.

At 2112, the MS may obtain a measurement report. For example, 2112 may be performed by configuration component 2216 of network entity 2260. The MS may obtain, from the UE, the measurement report via the radio channel based on the measurement configuration.

At 2114, the MS may provide the measurement report to the CS. For example, 2114 may be performed by configuration component 2216 of network entity 2260.

At 2116, the MS may obtain a cancellation request. For example, 2116 may be performed by configuration component 2216 of network entity 2260. The MS may obtain the cancellation request to stop providing the measurement report of the UE.

At 2118, the MS may provide an indication to instruct the U to stop reporting measurements. For example, 2118 may be performed by configuration component 2216 of network entity 2260. In some aspects, an association between the UE and the MS may be terminated in response to providing the indication to stop reporting measurements.

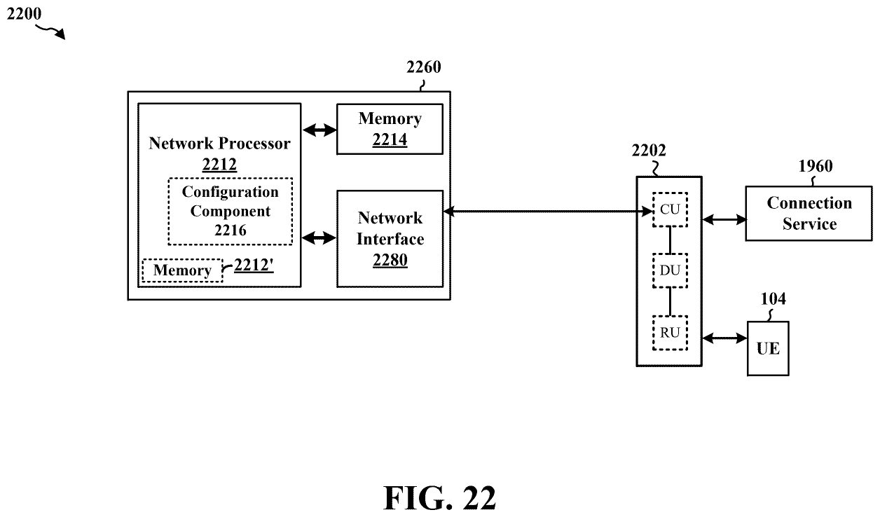

FIG. 22 is a diagram 2200 illustrating an example of a hardware implementation for a network entity 2260. In one example, the network entity 2260 may be within the core network 120. The network entity 2260 may include at least one network processor 2212. The network processor(s) 2212 may include on-chip memory 2212′. In some aspects, the network entity 2260 may further include additional memory modules 2214. The network entity 2260 communicates via the network interface 2280 directly (e.g., backhaul link) or indirectly (e.g., through a RIC) with the CU 2202. The on-chip memory 2212′ and the additional memory modules 2214 may each be considered a computer-readable medium/memory. Each computer-readable medium/memory may be non-transitory. The network processor(s) 2212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 2216 may be configured to obtain a request for delivery of a measurement report from a UE; provide, to the UE, a measurement configuration via a radio channel of an eDU; obtain, from the UE, a measurement report via the radio channel based on the measurement configuration; and provide the measurement report to at least a CS. The component 2216, and or the network entity 2260, may be further configured to perform any of the aspects described in connection with the flowcharts in any of FIG. 17 or 18, and/or performed by the MS in the communication flow in any of FIGS. 8-10. The component 2216 may be within the network processor(s) 2212. The component 2216 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2260 may include a variety of components configured for various functions. In one configuration, the network entity 2260 may include means for obtaining a request for delivery of a measurement report from a UE. The network entity includes means for providing, to the UE, a measurement configuration via a radio channel of an eDU. The network entity includes means for obtaining, from the UE, a measurement report via the radio channel based on the measurement configuration. The network entity includes means for providing the measurement report to at least a CS. The network entity further includes means for establishing an association with the UE. The network entity further includes means for obtaining neighbor cell information associated with the UE. The network entity further includes means for deriving at least part of the measurement configuration based on the neighbor cell information. The network entity further includes means for obtaining cancellation request to stop providing the measurement report of the UE. The network entity further includes means for providing an indication to instruct the UE to stop reporting measurements. The network entity 2260 may further include means for performing any of the aspects described in connection with the flowcharts in any of FIG. 17 or 18, and/or performed by the MS in the communication flow in any of FIGS. 8-10. The means may be the component 2216 of the network entity 2260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented. The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. One or more processors may be referred to as processor circuitry. Memory/memory module may be referred to as memory circuitry, at least one memory, or one or more memories. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a CS comprising establishing a first association with a UE via a first radio channel with a first eDU; providing, to the UE, a configuration of a second association for communication with a MS; and providing, to the MS, a request for delivery of a measurement report from the UE.

Aspect 2 is the method of aspect 1, further including selecting the MS to obtain the measurement report from the UE.

Aspect 3 is the method of any of aspects 1 and 2, further includes that the request for the delivery of the measurement report is provided to the MS.

Aspect 4 is the method of any of aspects 1-3, further includes that the request comprises at least one of a UE ID, an eDU ID, a CS ID, or a security key for communication between the MS and UE.

Aspect 5 is the method of any of aspects 1-4, further including initiating a switch to a target eDU based on the measurement report obtained from the MS.

Aspect 6 is the method of any of aspects 1-5, further including providing the MS with a target eDU ID in response to the switch to the target eDU.

Aspect 7 is the method of any of aspects 1-6, further including cancelling delivery of the measurement report for the UE in response to a release of the connection of the UE or receipt of an indication of the release of the UE.

Aspect 8 is the method of any of aspects 1-7, further including providing a migration request to a target MS to provide the measurement report of the UE to the CS, wherein the measurement report is provided to the target MS; and providing an instruction to a source MS to cancel delivery of the measurement report to the CS.

Aspect 9 is an apparatus for wireless communication at a CS including at least one processor coupled to a memory and at least one transceiver, the at least one processor configured to implement any of aspects 1-8.

Aspect 10 is an apparatus for wireless communication at a CS including means for implementing any of aspects 1-8.

Aspect 11 is a computer-readable medium (e.g., non-transitory computer-readable medium) storing computer executable code, where the code when executed by one or more processors causes the one or more processors to implement any of aspects 1-8.

Aspect 12 is a method of wireless communication at a MS comprising obtaining a request for delivery of a measurement report from a UE; providing, to the UE, a measurement configuration via a radio channel of an eDU; obtaining, from the UE, the measurement report via the radio channel based on the measurement configuration; and providing the measurement report to at least a CS.

Aspect 13 is the method of aspect 12, further includes that the request comprises at least one of a UE ID, an eDU ID, a CS ID, or a security key for communication between the MS and the UE.

Aspect 14 is the method of any of aspects 12 and 13, further includes that the request is obtained from the CS or the eDU.

Aspect 15 is the method of any of aspects 12-14, further including establishing an association with the UE.

Aspect 16 is the method of any of aspects 12-15, further includes that the request for the measurement report indicates, or comprises, the request without reference to the UE.

Aspect 17 is the method of any of aspects 12-16, further including obtaining neighbor cell information associated with the UE; and deriving at least part of the measurement configuration based on the neighbor cell information.

Aspect 18 is the method of any of aspects 12-17, further including obtaining cancellation request to stop providing the measurement report of the UE; and providing an indication to instruct the UE to stop reporting measurements.

Aspect 19 is the method of any of aspects 12-18, further includes that an association between the UE and the MS is terminated in response to providing the indication to stop reporting measurements.

Aspect 20 is an apparatus for wireless communication at a network entity including at least one processor coupled to a memory and at least one transceiver, the at least one processor configured to implement any of aspects 12-19.

Aspect 21 is an apparatus for wireless communication at a network entity including means for implementing any of aspects 12-19.

Aspect 22 is a computer-readable medium (e.g., non-transitory computer-readable medium) storing computer executable code, where the code when executed by one or more processors causes the one or more processors to implement any of aspects 12-19.

What is claimed is:

1. An apparatus for wireless communication at a connectivity service (CS), comprising:
at least one memory; and
at least one processor coupled to the at least one memory and, based at least in part on information stored in the at least one memory, the at least one processor, individually or in any combination, is configured to cause the apparatus to:
establish a first association with a user equipment (UE) via a first radio channel with a first enhanced distributed unit (eDU);
provide, to the UE, a configuration of a second association for communication with a measurement service (MS); and
provide, to the MS, a request for delivery of a measurement report from the UE.

2. The apparatus of claim 1, further comprising a transceiver coupled to the at least one processor, the transceiver being configured to:
provide, to the UE, the configuration of the second association for the communication with the MS; and
provide, to the MS, the request for the delivery of the measurement report from the UE.

3. The apparatus of claim 1, wherein the at least one processor is configured to cause the apparatus to:
select the MS to obtain the measurement report from the UE.

4. The apparatus of claim 1, wherein the request for the delivery of the measurement report is provided to the MS.

5. The apparatus of claim 4, wherein the request comprises at least one of a UE identifier (ID), an eDU ID, a CS ID, or a security key for communication between the MS and the UE.

6. The apparatus of claim 1, wherein the at least one processor is configured to cause the apparatus to:
initiate a switch to a target eDU based on the measurement report obtained from the MS.

7. The apparatus of claim 6, wherein the at least one processor is configured to cause the apparatus to:
provide the MS with a target eDU ID in response to the switch to the target eDU.

8. The apparatus of claim 7, wherein the at least one processor is configured to cause the apparatus to:
cancel the delivery of the measurement report for the UE in response to a release of a connection of the UE or receipt of an indication of the release of the UE.

9. The apparatus of claim 1, wherein the at least one processor is configured to cause the apparatus to:
provide a migration request to a target MS to provide the measurement report of the UE to the CS, wherein the measurement report is provided to the target MS; and
provide an instruction to a source MS to cancel the delivery of the measurement report to the CS.

10. A method of wireless communication at a connectivity service (CS), comprising:
establishing a first association with a user equipment (UE) via a first radio channel with a first enhanced distributed unit (eDU);
providing, to the UE, a configuration of a second association for communication with a measurement service (MS); and
providing, to the MS, a request for delivery of a measurement report from the UE.

11. The method of claim 10, further comprising:
selecting the MS to obtain the measurement report from the UE.

12. The method of claim 10, further comprising:
initiating a switch to a target eDU based on the measurement report obtained from the MS.

13. The method of claim 12, further comprising:
providing the MS with a target eDU ID in response to the switch to the target eDU.

14. The method of claim 13, further comprising:
cancelling the delivery of the measurement report for the UE in response to a release of a connection of the UE or receipt of an indication of the release of the UE.

15. The method of claim 10, further comprising:
providing a migration request to a target MS to provide the measurement report of the UE to the CS, wherein the measurement report is provided to the target MS; and
providing an instruction to a source MS to cancel the delivery of the measurement report to the CS.

16. An apparatus for wireless communication at a measurement service (MS), comprising:
at least one memory; and
at least one processor coupled to the at least one memory and, based at least in part on information stored in the at least one memory, the at least one processor, individually or in any combination, is configured to cause the apparatus to:
obtain a request for delivery of a measurement report from a user equipment (UE);
provide, to the UE, a measurement configuration via a radio channel of an enhanced distributed unit (eDU);
obtain, from the UE, the measurement report via the radio channel based on the measurement configuration; and
provide the measurement report to at least a connection service (CS).

17. The apparatus of claim 16, further comprising a transceiver coupled to the at least one processor, the transceiver being configured to:
obtain the request for the delivery of the measurement report from the UE;
provide, to the UE, the measurement configuration via the radio channel of the eDU;
obtain, from the UE, the measurement report via the radio channel based on the measurement configuration; and
provide the measurement report to at least the CS.

18. The apparatus of claim 16, wherein the request comprises at least one of a UE identifier (ID), an eDU ID, a CS ID, or a security key for communication between the MS and the UE.

19. The apparatus of claim 16, wherein the request is obtained from the CS or the eDU.

20. The apparatus of claim 16, wherein the at least one processor is configured to cause the apparatus to:
establish an association with the UE.

21. The apparatus of claim 16, wherein the request for the measurement report indicates the request without reference to the UE.

22. The apparatus of claim 16, wherein the at least one processor is configured to cause the apparatus to:
obtain neighbor cell information associated with the UE; and
derive at least part of the measurement configuration based on the neighbor cell information.

23. The apparatus of claim 16, wherein the at least one processor is configured to cause the apparatus to:
obtain cancellation request to stop providing the measurement report of the UE; and
provide an indication to instruct the UE to stop reporting measurements.

24. The apparatus of claim 23, wherein an association between the UE and the MS is terminated in response to providing the indication to stop the reporting measurements.

25. A method of wireless communication at a measurement service (MS), comprising:
obtaining a request for delivery of a measurement report from a user equipment (UE);
providing, to the UE, a measurement configuration via a radio channel of an enhanced distributed unit (eDU);
obtaining, from the UE, the measurement report via the radio channel based on the measurement configuration; and
providing the measurement report to at least a connection service (CS).

26. The method of claim 25, wherein the request comprises at least one of a UE identifier (ID), an eDU ID, a CS ID, or a security key for communication between the MS and the UE.

27. The method of claim 25, further comprising:
establishing an association with the UE.

28. The method of claim 25, wherein the request for the measurement report indicates the request without reference to the UE.

29. The method of claim 25, further comprising:
obtaining neighbor cell information associated with the UE; and
deriving at least part of the measurement configuration based on the neighbor cell information.

30. The method of claim 25, further comprising:
obtaining cancellation request to stop providing the measurement report of the UE; and
providing an indication to instruct the UE to stop reporting measurements.
